(19) United States
(12) Patent Application Publication
(10) Pub. No.: US 2026/0160985 A1
(43) Pub. Date: Jun. 11, 2026

(54) METHOD AND DEVICE FOR ILLUMINATING AND IMAGING A SAMPLE IN A LIGHT MICROSCOPE

(71) Applicant: ABBERIOR INSTRUMENTS GMBH, Gottingen (DE)

(72) Inventor: Roman SCHMIDT, Gottingen (DE)

(21) Appl. No.: 19/179,151

(22) Filed: Apr. 15, 2025

(30) Foreign Application Priority Data
Apr. 23, 2024 (DE) 10 2024 111 345.6

(51) Int. Cl. G02B 21/00; G01N 21/64; G01N 21/65

(52) U.S. Cl. CPC G02B 21/0032; G02B 21/008; G01N 2021/6439; G01N 21/65

(57) ABSTRACT

The present disclosure relates to an illumination and imaging method for light microscopy, wherein the illumination takes place at different axial positions in a sample, or parts of the sample are imaged from different depths. The present disclosure further relates to localization methods for individual emitters in a sample using such an illumination method, in particular to localization methods according to the MINFLUX principle. Finally, the present disclosure comprises a light microscope for carrying out an illumination, imaging and/or localization method according to the present disclosure.

### CROSS-REFERENCE TO RELATED APPLICATIONS

This application claims priority to German Patent Application DE 10 2024 111 345.6 filed on Apr. 23, 2024, the disclosure of which is incorporated herein by reference in its entirety.

### TECHNICAL FIELD

The present disclosure relates to a group of related methods and to corresponding devices for illuminating and/or imaging a sample in a light microscope, wherein the illumination of the sample is carried out at different depths or parts of the sample are imaged from different depths. The present disclosure also relates to methods for localizing individual emitters in a sample using these illumination and/or imaging methods and to a light microscope for carrying out one of these illumination, imaging and/or localization methods.

### PRIOR ART

In light microscopy, the problem with imaging three-dimensionally extended objects is that a sample is only imaged sharply in one plane with a microscope objective. For the three-dimensional imaging of an object or a non-planar substructure of an object, it is therefore necessary to record several layers of the object and generate a representation of the three-dimensional object or substructure from the layer images. This is made more difficult by the fact that image information from sample areas above and below the plane of focus is superimposed on the image information in the plane of focus and reduces its image contrast.

In confocal laser scanning microscopy, this problem is addressed by illuminating the object only point by point with focused laser light and creating a three-dimensional image by scanning the sample with the focused laser light in several successive illumination planes. A point detector arranged confocally to the illumination point or a confocal aperture ensures the suppression of signal contributions from areas above and below the illumination plane (optical sectioning).

In light sheet microscopy, a concept of selective illumination of the sample is also pursued, wherein the sample is illuminated here with a laterally irradiated illumination light beam or light sheet in only one plane, so that the sample is only stimulated to emit an emission (e.g. fluorescence) in this plane, while no emission is stimulated above and below this plane. Light sheet microscopy thus enables optical sectioning even without a confocal pinhole and allows the simultaneous acquisition of an entire slice image without the need for (lateral) scanning.

In the MINFLUX method introduced by F. Balzarotti et al. in “Nanometer resolution imaging and tracking of fluorescent molecules with minimal photon fluxes”, Science 355 (6325), 606 (2017), DOI: 10.1126/science.aak9913 for localizing and tracking an isolated emitter, light distributions of illumination light are formed in the sample, which excite light emissions from the emitter, wherein the light distributions comprise a local intensity minimum. The position of an isolated emitter is determined from the light emissions detected for different positions of the intensity minimum or for different such light distributions in a close range around the emitter. In particular, it is utilized that the smaller the distance between the emitter and the intensity minimum of the light distribution, the less light is emitted by the emitter. In the intensity minimum itself, the emitter should be stimulated to emit as little as possible so that the increase in emission with increasing distance from the intensity minimum of the light distribution is as large as possible in relation to the emission. For this reason, MINFLUX methods are particularly photon-efficient, especially in comparison to localization methods based on spatially resolved detection of the emission, such as PALM or STORM microscopy. This means that a particularly high localization accuracy can be achieved with MINFLUX methods for the same number of detected photons.

In the related STED-MINFLUX method disclosed in the publications US 2018/0259458 A1 and US 2020/0393378 A1, a single emitter is also illuminated with a light distribution comprising a local intensity minimum. As in the MINFLUX method described above, the light distribution is placed at a plurality of illumination positions around the (presumed) location of the individual emitter, and a light emission is detected for each illumination position. The position of the emitter is estimated with high precision from the light emissions obtained in this way. In contrast to the original MINFLUX method, however, the light distribution is not a distribution of excitation light, but a distribution of modulation light that reduces the emission of the emitter. The modulation light is in particular fluorescence inhibition light, i.e., stimulation or STED light, which is used together with (additional) excitation light, wherein the intensity distribution of the excitation light does not have a central local minimum. While the fluorescence emission is higher in the MINFLUX method, when the isolated emitter is further away from the central intensity minimum of the light distribution, the opposite is true in this method.

The MINFLUX and STED-MINFLUX methods also require the sample to be illuminated at illumination positions at different depths of the sample in order to enable three-dimensional localization of individual emitters. For example, the publication US 2023/0350179 A1 discloses a method for high-resolution localization of an emitter in three spatial directions, in which the intensity minimum of the illumination light is placed at two axial positions above and below the focal plane in an axial localization step and at several illumination positions in the focal plane in a lateral localization step.

In all the forms of light microscopy described, it is necessary to image planes at different depths in the sample or to focus illumination light at different depths in the sample. This is usually done by varying the distance between the microscope objective and the sample, either by fixing the sample and moving the objective relative to the sample or by moving the sample relative to the fixed objective. Both embodiments require mechanical movement of components of the imaging system, which results in disturbing effects. In particular, the mass of the moving components limits the focusing speed, i.e., the speed at which the focal plane can be adjusted or tracked. Since the moving mass is regularly in the range of a few hundred grams (e.g. height-adjustable sample stage or objective with longitudinal drive), but can also be considerably higher and, for example, comprise the entire turret unit of a microscope stand, focusing is several orders of magnitude slower than the lateral displacement of a laser beam with galvanometer mirrors in a laser scanning microscope, which typically takes place within a millisecond.

In addition, moving components are generally more susceptible to instabilities and drifts than fixed components, and especially after an adjustment, a settling of the components can be observed over a period of minutes to hours. Demanding applications with high requirements for position stability therefore often require complex active position tracking in order to compensate for the settling of the components.

In certain applications in which, in addition to light microscopy imaging of the sample, other measurements such as electrophysiological measurements are carried out with patch clamp pipettes or microelectrodes finely positioned in the sample, movement of the sample relative to the microscope stand is completely out of the question.

In view of the problems mentioned, focusing the sample or shifting the focus of illumination axially using purely optical means is desirable. In this respect, various possibilities for a fast focus shift in the axial direction are described in the prior art, but these are technically demanding to realize and costly. In “Fast varifocal lenses using KTa₁₋ₓNbₓO₃ crystals and a simulation method with electrostrictive calculations”, Appl. Opt. 51 (10), 1532-1539 (2012), DOI: 10.1364/AO.51.001532, T. Imai et al. describe a now commercially available Kerr lens based on a potassium tantalate niobate (KTN) single crystal, whose focal length can be shifted by almost 90 mm on a time scale of a few microseconds, although this requires switching voltages of several hundred volts. Lenses with adjustable focal lengths can also be designed as liquid lenses in which a liquid optical medium is enclosed by transparent membranes. By varying the distance between the membranes at a constant liquid volume, the curvature of the membrane surfaces can be varied from concave to convex and thus the focal length of the lens can be varied over a wide range [see, for example, M. Blum et al, “Compact optical design solutions using focus tunable lenses”, SPIE Optical Design and Engineering IV, Proceedings Vol. 8167, 81670W (2011), DOI: 10.1117/12.897608]. With a moving coil drive, such arrangements can achieve switching times in the range of a few milliseconds. However, a disadvantage of tunable liquid lenses is that they can be subject to gravity-induced deformations, especially when operating in an upright orientation, which results in coma aberrations.

Another class of electrically tunable lenses are liquid crystal lenses whose focal length results from a spatially varying refractive index of differently aligned liquid crystals, where the alignment is controlled by applied electric fields [see, for example, H.-C. Lin and Y.-H. Lin in “An electrically tunable-focusing liquid crystal lens with a low voltage and simple electrodes”, Opt. Expr. 20 (3), 2045-2052 (2012), DOI: 10.1364/OE.20.002045].

However, a fundamental problem with optical focus shifting by prefocusing or defocusing is that even slight prefocusing causes significant spherical aberrations in microscopes with a high numerical aperture and imaging without considerable loss of quality is only possible if special boundary conditions are met, as described, for example, by E. J. Botcherby et al. in “Aberration-free optical refocusing in high numerical aperture microscopy”, Opt. Lett. 32 (14), 2007 (2007), DOI: 10.1364/OL.32.002007. In patent applications US 2010/053735 A1, US 2012/062986 A1 and US 2013/0215502 A1, the authors disclose a method and a device for focusing a sample in a microscope with a (primary) objective with a high numerical aperture, in which movement of the sample for the purpose of focusing is avoided and a higher axial scanning speed is made possible. In this method, known as remote focusing, the sample is first imaged into an intermediate image space in an imaging and recording device. A final image of the sample is generated by further imaging of this intermediate image space, wherein focus adjustment devices are used to select an image plane to be imaged sharply in the intermediate image space, but the sample and the optical elements imaging the sample in the intermediate image space are not moved. This further imaging may be a direct optical imaging (for example onto a camera) or can also be carried out by laser scanning. The imaging device comprises at least one lens or a secondary objective with a high numerical aperture and is designed in such a way that spherical aberrations are avoided. In a specific embodiment, the intermediate image space is imaged with a third objective lens arranged in the transmission direction relative to the secondary objective lens, the respective sharply imaged image plane being selected by an axial displacement of the third objective lens. In a further embodiment, a mirror that can be displaced in the direction of the optical axis of the secondary objective is arranged in the intermediate image space of the secondary objective, which reflects the intermediate image of the sample back to the secondary objective, so that the intermediate image space is also imaged by the secondary objective to record the final image. The selection of the sharply imaged image plane in the intermediate image space is done by an axial displacement of the mirror.

The term Oblique Plane Microscopy (OPM) refers to a variant of remote focusing in which the sharply imaged plane of the intermediate image space is not perpendicular to the optical axis, but is inclined relative to the optical axis. For this purpose, either the optical axes of the secondary objective and the third objective are tilted relative to each other or the reflecting mirror in the intermediate image space is tilted relative to the optical axis of the secondary objective, so that a plane of the sample is imaged in focus that is inclined relative to the focal plane of the primary objective. In extreme cases, the sharply imaged plane can be perpendicular to the focal plane, so that direct imaging of an axial section of the sample is possible (Axial Plane Optical Microscopy, APOM). OPM has particular advantages in the optimized acquisition of volumetric image data and in combination with light sheet microscopy. For an overview of the prior art in OPM, please refer to the review article by J. Kim, “Recent advances in oblique plane microscopy”, Nanophoton. 12 (13), 2317 (2023), DOI: 10.1515/nanoph-2023-0002.

M. Žurauskas et al. describe an alternative embodiment of remote focusing in the publication “Rapid adaptive remote focusing microscope for sensing of volumetric neural activity”, Opt. Expr. 8, 4369 (2017), DOI: 10.1364/BOE.8.004369, in which a deformable mirror is arranged in a plane conjugate to the objective pupil instead of a movable mirror or a movable secondary objective in the intermediate image space. Remote focusing thus takes place in Fourier space by presenting a defocus of different amplitude on the deformable mirror, wherein spherical aberrations can be compensated for simultaneously with the deformable mirror.

### Objective

The objective of the present disclosure is now to provide illumination and imaging methods for light microscopy and a corresponding light microscope, with which a sample can be illuminated at different axial positions, i.e., at different positions along an optical axis, or a non-planar surface in the sample can be imaged sharply. The objective of the present disclosure is further to provide a method for the three-dimensional localization of an emitter in a sample, wherein the emitter is illuminated at different illumination positions, also in the axial direction, and the position of the emitter is determined from the light emissions of the emitter detected at the illumination positions.

### Solution

This objective is attained by the subject matter of the independent method claims 1 and 14 and by a light microscope according to the independent claim 18. Advantageous embodiments of the methods are given in subclaims 2 to 13 and 15 to 17, and advantageous embodiments of the light microscope are given in subclaims 19 to 25.

### Description

A first aspect of the present disclosure relates to a method for illuminating a sample in a light microscope, wherein the sample is illuminated through a microscope objective at a plurality of illumination positions with focused illumination light, wherein the illumination light is phase-delayed in a varying manner over an intermediate image plane in an intermediate image space of an illumination beam path, so that the illumination light is focused at different depths in the sample.

The method can be used in particular in the context of confocal laser scanning microscopy to scan the sample with focused illumination light point by point over an area, or in the context of MINFLUX microscopy to position the focused illumination light, which then comprises a central intensity zero point, at a plurality of scanning positions. However, the illumination method can also be used with other examination methods, for example to measure the response of a sample to illumination with illumination light at a plurality of illumination positions positioned in three-dimensional space—also repeatedly. Finally, the illumination method can also be used to manipulate the sample, for example to produce three-dimensional microscopic or nanoscopic structures by nanolithography.

The method shares the basic principle of shifting the placement of the illumination positions (by optical imaging) from the sample into an intermediate image space in the illumination beam path with the remote focusing method known from the prior art. To illuminate the sample, a focus is formed with the illumination light in the intermediate image space, which illuminates it in a point-like manner after imaging into the sample. Different illumination positions in the sample, which also differ in their axial position, can thus be addressed by shifting the illumination focus in the intermediate image space, wherein boundary conditions may have to be observed with regard to the axial direction in order to avoid the occurrence of (spherical) aberrations. According to the present disclosure, an axial shift of the illumination focus is effected by varying the phase delay or the optical path length in the intermediate image space, wherein the phase delay or the optical path length has different amounts for different lateral positions. For a given spatial distribution of the phase delay, illumination positions at different depths in the sample can thus be addressed by exclusively laterally shifting the illumination focus in the intermediate image space without having to change the amount or spatial distribution of the phase delay or mechanically move optical components.

Depending on the context in which the illumination method according to the present disclosure is used, the range in which the illumination positions must be arranged in the sample in the axial direction differs. While in the application in MINFLUX microscopy the illumination positions are usually arranged within a range of less than one micrometer in order to localize an emitter in three dimensions, this is usually not sufficient for imaging three-dimensionally extended objects in the sample, here the illumination positions typically extend over several micrometers. In this respect, not all available phase modulators are equally suitable for use in the method according to the present disclosure, since many available phase modulators, in particular those based on liquid crystals, are only designed for a phase shift in the order of magnitude of one wavelength of the illumination light. (In contrast to many applications of phase modulators for optical aberration correction, in which effectively only the phase delay modulo 2π is effective and a phase change is unproblematic, the absolute amount of the phase delay or the optical path length change is decisive for the present disclosure). In this respect, according to particular embodiments of the method, a maximum adjustable phase delay is at least twice a wavelength of the illumination light, particularly at least five times a wavelength of the illumination light, more particularly at least ten times a wavelength of the illumination light.

In a simple embodiment of the method, an optical element with a spatially varying height profile, for example a stepped mirror or a mirror with a height relief, can be used for phase delay in the intermediate image space: Depending on the lateral position of the illumination focus on this element, the phase delay varies and shifts the illumination focus in the intermediate image space in the axial direction. However, since the axial coordinate of an illumination position is linked to its lateral coordinates, different illumination positions that differ only in their axial coordinate cannot be realized with such a static phase distribution.

In certain embodiments of the method therefore, reflective phase modulators, i.e., phase modulators operated in reflection and freely programmable, in particular deformable mirrors, segmented mirrors or micromirror arrays with an adjustable shift per micromirror are used in particular. Embodiments in which the phase delay element is arranged as a retroreflector in a focal plane of a secondary objective are advantageous. According to these embodiments, the intermediate image space is imaged into the sample with an optical system comprising the microscope objective, a secondary objective and a relay optics, wherein the intermediate image space comprises a focal plane of the secondary objective. An incident illumination light beam is focused onto the phase delay element by the secondary objective, the reflected illumination light is (largely) recollimated by the same secondary objective, imaged into a pupil of the microscope objective by the relay optics and focused into the sample by the latter.

According to an embodiment of the illumination method, a spatial distribution of the phase delay over the intermediate image plane is set such that the illumination positions are arranged on a curved contour of an object in the sample. The curved contour may be two- or three-dimensional, i.e., linear or areal, wherein the curved contour comprises points with different axial coordinates. When using the illumination method in the context of confocal laser scanning microscopy, it is now possible to scan the sample not only in a plane, but also on a surface of any shape. It is particularly advantageous to apply the described illumination method vice versa to emission light emitted from the sample, in particular fluorescence light, i.e., to delay the emission light in an intermediate image space in a detection beam path as a function of the lateral position and thus to achieve a sharp image or confocal detection of emission light not only from a plane, but from a surface of any shape. The same device can be used for phase delay of both the illumination light and the emission light and, in particular, can be arranged in a common beam path of the illumination and emission light. This embodiment is particularly useful for imaging structures on the surface of cells in the sample. While in conventional confocal laser scanning microscopy the problem often arises that the cell surface is highly curved and consequently a confocal image acquisition is only sharp within a small area of the cell surface or an acquisition of a three-dimensional image stack of the cell is required, scanning according to the method according to the present disclosure is not limited to a plane in the sample, but allows scanning and, if necessary, imaging of the cell surface along an arbitrarily shaped cell surface.

According to a further embodiment of the illumination method, the spatial distribution of the phase delay over the intermediate image plane is set such that the illumination positions are directed to different objects in the sample that have different axial positions. Different objects may be, for example, different cells or different cell organelles of a cell in the sample. In particular, if the illumination method is used in the context of localization microscopy, the objects may also be individual emitters.

A second aspect of the present disclosure relates to a method for localizing an emitter in a sample using the previously described illumination method. According to the localization method, for each illumination position, a quantity of light of an emission light emitted by the emitter in the sample is detected and a position of the emitter in the sample is determined from the quantities of light detected for the illumination positions.

The term emitter is understood here to mean molecules, molecule complexes or particles that emit light as a result of illumination with the illumination light or another excitation light, wherein the emission light may be fluorescence light in particular, but also (Rayleigh or Raman) scattered light. Accordingly, emitters may be, for example, individual fluorophores or molecules of a fluorescent dye, molecules or molecule complexes labeled with one or more fluorophores or so-called quantum dots. Furthermore, an emitter may also be, for example, a light-scattering nanoparticle, such as a gold nanoparticle.

In the localization method according to the present disclosure, the illumination positions are arranged in a close range around the presumed (and previously separately estimated) location of the emitter in the sample, wherein the illumination positions are typically arranged within an Airy disk around the presumed location of the emitter, i.e., at a distance below 150 nm. The emitter is then located in an area in which the focused illumination light comprises a steep intensity gradient and even slight changes in the distance translate into a significant change in the amount of light emitted by the emitter per unit time. For each illumination position, a quantity of light emitted by the emitter is detected and assigned to the respective illumination position. From these assignments, the location of the emitter in the sample can be determined with an accuracy (far) below the optical diffraction limit. In the simplest case, this is done by forming the sum of the location vectors of the illumination positions weighted by the light quantities or with the aid of a maximum likelihood estimator (MLE)

Optionally, the first localization of the emitter can be followed by one or more further localizations of the same emitter in order to (further) reduce the location uncertainty of the localization, wherein the illumination positions are each updated on the basis of a previous localization of the emitter and are particularly arranged more closely around the location of the emitter. An adjustment, in particular an increase in the overall intensity of the illumination light, can also improve the accuracy of the localization. It is also possible to determine the location of an emitter several times in succession so that the location can be specified as a function of time (“tracking”).

According to an embodiment of the localization method, the focus of the illumination light in the sample comprises a local intensity minimum surrounded by intensity increase regions in at least one spatial direction, wherein the local intensity minimum may be point-shaped, linear, or areal. Such intensity distributions can be generated by phase modulation of the wavefront of the illuminating light and are well known from the prior art. These embodiments are therefore localization methods from the MINFLUX or STED-MINFLUX family, which comprise a particular photon efficiency, i.e., achieve a particularly high localization accuracy from a given amount of emission light.

In the various embodiments of the localization method, the illumination light is in particular excitation light that excites the emitter to emit light, in particular fluorescence, or is scattered by the emitter, i.e., induces light emission. Alternatively, the illumination light is a modulation light that modulates the light emission of the emitter, in particular a modulation light that inhibits the light emission. Examples of this are STED light, which quenches the excited state of fluorophores through stimulated emission, or switching light, which can, for example, convert fluorophores from a fluorescent state to a dark state, such as a triplet state. Illumination light, which modulates the light emission, is used in particular in combination with an additional excitation light.

In an embodiment of the localization method, the position determination of the emitter comprises an axial coordinate of the emitter, wherein the position of the emitter in the sample is particularly determined in all spatial directions. In order to be able to determine the axial coordinate of the emitter, it is necessary to arrange the illumination positions not only in a single plane perpendicular to the optical axis, but at illumination positions with different axial coordinates. By setting a corresponding spatially varying phase delay in the intermediate image space of the illumination beam path, different illumination positions can be generated laterally at different depths of the sample without having to move the microscope objective, the sample or an optical element in the illumination beam path in the axial direction. To do this, it is sufficient to laterally shift the illumination focus in the intermediate image space, for example with a galvanometer scanner arranged in front of the intermediate image in the direction of illumination.

At least four illumination positions are required to localize the emitter in three dimensions, wherein an arrangement of the illumination positions at the corners of a regular polyhedron or a polyhedron stretched in the axial direction can be used in particular. The simplest arrangement is therefore an arrangement of four illumination points at the corners of a tetrahedron. In this respect, the illumination positions according to an embodiment comprise at least two groups with at least two illumination positions each or at least one group with at least three illumination positions, wherein the illumination positions within a group comprise the same axial coordinates.

According to a further embodiment of the localization method, the positions of a first and a second emitter in the sample are determined quasi-simultaneously by illuminating the sample in turns at illumination positions assigned to the first emitter and at illumination positions assigned to the second emitter. The emission light detected during this process is assigned to the respective emitter so that the position of both emitters can be determined separately. The positions of the first and second emitters can also differ from each other, particularly in their axial coordinates.

The two emitters can be illuminated alternately, although this is not essential. Other sequences—for example two illumination positions for the first emitter followed by two illumination positions for the second emitter—are also possible and may be particularly advantageous. The emitters do not have to be illuminated evenly, i.e., with the same number of illumination positions per step or in total. Rather, the number of illumination positions may be individually adapted, for example to the amounts of emission light already detected by the emitters, to their brightness (i.e., the amount of emission light emitted per unit of time) or to the type of emitter (in the event that the emitters are of different types).

In the embodiments for quasi-simultaneous localization of several emitters, it should be noted that the position of the emitters can only be determined separately if the emitters are spatially separated in the sample, i.e., at a (lateral) distance of more than one diffraction limit, and can be optically separated from each other. Otherwise, it is not possible to clearly assign the detected light emission to one of the emitters. If this boundary condition is met, more than two emitters can also be localized quasi-simultaneously without further ado. During the quasi-simultaneous localization of several emitters, further emitters can also be added dynamically, or emitters can be eliminated. For example, the method can be designed so that a constant number of emitters are always illuminated in turns, wherein a new emitter is always added when a sufficient amount of emission light has been detected from another emitter for localization, or another emitter has been bleached.

A third aspect of the present disclosure relates to a method for imaging a sample into an image plane of a light microscope, wherein detection light originating from the sample is phase-delayed in a varying manner over an intermediate image plane in an intermediate image space of the light microscope. The imaging of the sample into the image plane is therefore two-stage and comprises a first imaging of the sample into the intermediate image space and a second imaging of the intermediate image space into the image plane. A light detector is then usually arranged in the image plane, which may be configured as a (confocal) point detector or also as a spatially resolving area detector, in particular as a CMOS or CCD camera.

The imaging method corresponds conceptually to the illumination method described above but applies a spatially varying phase delay not to the illumination light, but to detection light propagating in the opposite direction from the sample. Because the detection light is phase-delayed differently at different points in the illumination plane, the imaging of the sample in the image plane in the intermediate image space can be adapted locally so that points in the intermediate image that correspond to points in the sample with different axial positions are also imaged in the same image plane.

The imaging method according to the present disclosure thus differs from the imaging methods known from the prior art in that it is possible to image objects not only in a plane, but also along or on a curved surface in the sample. In particular, the distribution of the phase delay over the intermediate image plane can be set such that a curved contour of an object, for example the surface of a cell, in the sample is imaged (continuously sharply) in the image plane. In order to be able to compensate for curvatures of objects to be examined (e.g. cells) that occur in practice, the phase delay in the intermediate image space may be set to at least twice a wavelength of the detection light, particularly at least five times a wavelength of the detection light, more particularly at least ten times a wavelength of the detection light.

According to an embodiment of the imaging method, the sample is also illuminated according to one of the previously described illumination methods. It is particularly advantageous to apply the phase delay, which varies across the intermediate image plane, in a common intermediate image space of the illumination light and the detection light and with identical devices. In addition to the economic advantage—phase delay elements are only necessary in a single fashion—a common phase delay of illumination and detection light ensures that the illumination positions and the points in the sample that are sharply imaged in the image plane coincide.

According to an embodiment of the imaging method, the phase delay in the intermediate image space is adjusted with a deformable mirror, a segmented mirror or a micromirror array with adjustable shift per micromirror. In a special variant of this embodiment, the individual elements of the phase modulator are not designed as reflecting micromirrors, but as light-sensitive pixels, which together form a spatially resolving area detector, i.e., a camera with axially adjustable pixels. In this embodiment, the phase modulator and the area detector therefore form a single unit, and further imaging of the phase modulator in the image plane can be omitted.

A fourth aspect of the present disclosure relates to a light microscope, in particular for carrying out one of the previously described illumination, localization and/or imaging methods. According to the present disclosure, the light microscope comprises an optical imaging system comprising a microscope objective directed at a sample, a secondary objective directed into an intermediate image space of the light microscope, and a relay optics configured to image pupils of the microscope objective and the secondary objective into one another. The light microscope further comprises a spatial phase modulator comprising a control device for setting a phase delay profile, wherein the spatial phase modulator is arranged in the intermediate image space of the light microscope and is configured to variably delay illumination light from a light source and/or detection light from the sample over an intermediate image plane.

In particular, the illumination light may be excitation light that excites fluorophores in the sample to fluoresce or is scattered by particles in the sample, wherein the fluorophores or the particles may be bound to structures in the sample as markers. Accordingly, the detection light may be fluorescent or scattered light in particular. In the context of STED microscopy, the illumination light may also be fluorescence quenching light, which suppresses fluorescence emission. Finally, the illumination light may also be activation or manipulation light, which is used to trigger a chemical or biochemical reaction in the sample in a spatially limited manner, for example activation of a photoactivatable fluorescent dye or (in optogenetic applications) expression of light-sensitive ion channels, transporters or enzymes.

The microscope objective, the secondary objective and the relay optics arranged between the two objectives together provide an image of the sample in the intermediate image space, with the relay optics imaging a light beam emerging from the pupil of the secondary objective into the pupil of the microscope objective (and vice versa), irrespective of the exit angle. The microscope objective and the secondary objective particularly comprise a numerical aperture of at least NA 0.5 and more particularly of at least NA 0.9. The relay optics may, for example, be composed of two, in particular achromatic, converging lenses in a 4f arrangement, wherein the outer focal points of the relay optics are located in the pupils of the objectives. However, the relay optics can also have a more complex structure and consist of several static and/or movable groups of optical elements, wherein the optical elements may in particular also include aspherical lenses or lenses made of optical materials with particularly low dispersion in order to reduce imaging errors. The relay optics may also be configured as a zoom optics in order to form an imaging system with a variable magnification.

In contrast to the meaning of the term phase delay in the narrower sense (in which only the phase position of the light within a period is of interest as a result), the phase delay here is to be understood as a change in the optical path length in the broader sense, in particular also a change in the optical path length by a multiple of the wavelength of the illumination or detection light.

The range in which the optical path length may be varied with the phase modulator, together with the magnification of the image of the sample in the intermediate image space provided by the microscope objective, the imaging system and the secondary objective, determines the axial range in which the focused illumination light can be shifted in the sample or from which the detection light can be imaged from the sample into a plane. In this respect, according to an embodiment of the light microscope, the phase modulator can be used to set a phase delay of at least twice a wavelength of the illumination light or the detection light, particularly of at least five times the wavelength of the illumination light or the detection light, more particularly of at least ten times the wavelength of the illumination light or the detection light.

In principle, the phase modulator may be configured as a transmissive or reflective phase modulator. The decisive factor is that the optical path length can be varied and thus the position of the intermediate focus in the intermediate image space can be shifted. The variation of the phase delay across the intermediate image plane may be discrete, i.e., through segments or pixels of the phase modulator whose phase delay may be individually controlled. The phase delay may also be varied continuously across the intermediate image plane, for example by a deformable reflective membrane. In particular, the spatial phase modulator arranged in the intermediate image space may be configured as a deformable or segmented mirror or as a micromirror array with an adjustable shift per micromirror.

In an embodiment, the light microscope comprises a light source for illumination light, a beam deflection unit arranged in a beam path of the illumination light and a focusing system which is configured to focus the illumination light into the intermediate image space. If the phase modulator is configured as a reflective element, the illumination light is focused in particular by the secondary objective, with which the illumination light focused on the phase modulator and reflected by it is further imaged into the sample via the relay optics and the microscope objective. If the phase modulator is configured as a transmissive element, the illumination light is particularly focused into the intermediate image space with a further third objective opposite the secondary objective and arranged confocally to it.

The beam deflection unit may be used to shift the illumination focus in the intermediate image space and thus vary the point of impact of the illumination focus on the spatial phase modulator. Depending on the phase delay of the spatial phase modulator set at the point of impact, the illumination focus is imaged by the imaging system into different depths in the sample. The beam deflection unit may be designed with mechanically rotatable mirrors, for example with galvanometer mirrors or piezoelectrically moved tiltable mirrors; however, acousto-optical deflectors (AOD) or electro-optical deflectors (EOD) may also be used as beam deflection units. The latter enable a particularly rapid change in the deflection angle but are polarization-dependent and limited to smaller deflection angles. While mechanical rotating mirrors have a real axis of rotation around which the mirror is rotated, the axis of rotation may also be an apparent or virtual axis, as is the case with acousto-optical and electro-optical deflectors. In particular, the (real or virtual) axis of rotation of the beam deflector unit lies in a plane conjugate to the pupil of the secondary objective and outside the imaging system, i.e., outside the optical system bounded by the secondary objective, the relay optics and the microscope objective, so that the imaging of the intermediate focus into the sample is not subject to deflection by the beam deflector unit.

According to a further embodiment of the light microscope, the light microscope comprises optical elements for imaging the intermediate image space into a detection plane and a light detector arranged in the detection plane. The detection light may in particular be fluorescent light, Rayleigh or Raman scattered light or illumination light reflected from the sample. In this embodiment, a surface in the sample is imaged into a plane in the intermediate image space, wherein the shape of the surface in the sample is defined by the phase delay profile applied to the phase modulator and, if the phase modulator is programmable, can be freely selected within the technical limits given by the phase modulator. The surface may, for example, be an inclined plane in the sample, but the surface may also follow the contour of an object in the sample, such as the surface of a cell. The surface does not necessarily have to follow a structure or a real (boundary) surface in the sample but can simply be selected so that several objects at different depths in the sample are imaged sharply.

When imaging the sample into the intermediate image space, it should be noted that error-free imaging can only be achieved if boundary conditions are met. The general rule for an optical imaging system is that points in a plane perpendicular to the optical axis are only imaged free of image errors if Abbe's sine condition is fulfilled, i.e., if the relationship M_{xy}=(n sin γ)/(n′ sin γ′) is fulfilled for any incident beam from the object space, which forms an angle of γ with the optical axis, and the corresponding beam in the image space, which forms an angle of γ′ with the optical axis, wherein M_{xy} is the lateral magnification of the image and n, n′ is the refractive index on the object and image sides. In contrast, for an image free of spherical aberrations in the axial direction, the Herschel condition M_{z}=[n sin²(γ/2)]/[n′ sin²(γ′/2)] must be fulfilled, where M_{z} is the axial magnification of the image. Both conditions can only be fulfilled if the magnification is isotropic, i.e., M_{xy}=M_{z}=n/n′; this results in an ideal imaging system that allows error-free imaging in three dimensions. However, the magnification of microscopes is (by definition) M_{xy}, M_{z}>>1, so that the requirements for an ideal imaging system are not met.

The imaging system of the light microscope according to the present disclosure formed by the microscope objective, the relay optics and the secondary objective, on the other hand, forms two microscopes in a back-to-back arrangement, so that the sample can be imaged into the intermediate image space with a total magnification close to one and the condition for an ideal imaging system can be (at least approximately) fulfilled. Therefore, according to an embodiment of the light microscope, the imaging system provides an image of the sample in the intermediate image space with a magnification of at least approximately n/n′, wherein n is a refractive index of an immersion medium in the sample and n′ is a refractive index of an immersion medium in the intermediate image space. A special case, which represents a further embodiment, arises if the secondary objective and the microscope objective of the light microscope have the same magnification and the relay optics comprises a magnification of one, in particular if the secondary objective and the microscope objective are identical in construction.

According to another embodiment of the light microscope, an aperture angle of the secondary objective is larger than an aperture angle of the microscope objective. If this feature is fulfilled, it is ensured that the resolving power of the entire light microscope is not limited by the secondary objective. For example, a light microscope according to the present disclosure can be constructed with a water immersion objective 60×/NA 1.2 as the microscope objective and an air objective 40×/NA 0.95 as the secondary objective, both of which are common objectives and are commercially available. The secondary objective then has an aperture angle of 71.8°, while the microscope objective has a smaller aperture angle of 64.5°.

Advantageous further embodiments of the present disclosure are shown in the claims, the description and the drawings and the associated explanations of the drawings. The described advantages of features and/or feature combinations of the present disclosure are merely exemplary and may have an alternative or cumulative effect. With regard to the disclosure (but not the scope of protection) of the original application documents and the patent, the following applies: Further features can be found in the drawings—in particular the relative arrangements and active compounds shown.

The combination of features of different embodiments of the present disclosure or of features of different claims is also possible, in deviation from the selected back relations of the claims and is hereby suggested. This also applies to those features which are shown in separate drawings or are mentioned in their description. These features can also be combined with features of different claims. Likewise, features listed in the claims can be omitted for further embodiments of the present disclosure, but this does not apply to the independent claims of the granted patent.

The reference signs contained in the claims do not constitute a limitation of the scope of the objects protected by the claims. They merely serve the purpose of making the claims easier to understand.

### BRIEF DESCRIPTION OF THE FIGURES

FIG. 1 shows an imaging system for an illumination method.

FIG. 2 shows the imaging system from FIG. 1 with two further directions of illumination.

FIG. 3 shows a section of an imaging system with a reflective phase modulator.

FIG. 4 shows a section of an imaging system with a transmissive phase modulator.

FIG. 5 shows a first light microscope.

FIG. 6 shows a second light microscope.

FIG. 7 shows a third light microscope.

### DESCRIPTION OF THE FIGURES

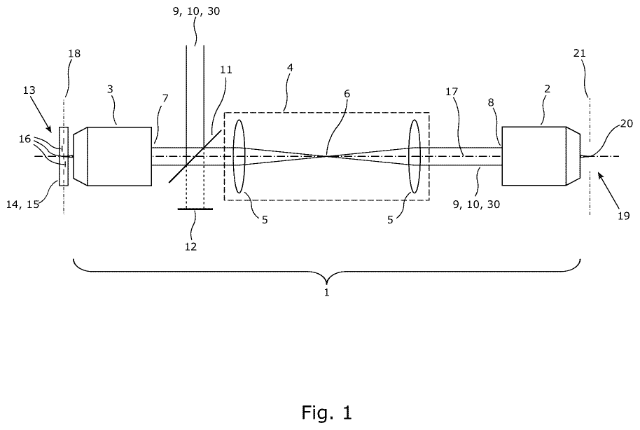

FIG. 1 shows an imaging system 1 for a light microscope according to the present disclosure and for carrying out an illumination method according to the present disclosure. The imaging system 1 comprises a microscope objective 2, a secondary objective 3 and a relay optics 4, which is formed here from two lenses 5. The relay optics 4 is designed in a 4f configuration with an intermediate focus 6 and configured to image the pupils 7, 8 of the microscope objective 2 and the secondary objective 3 into each other. An incident light beam 9 of the illumination light 10 is coupled into the beam path of the imaging system 1 and into the pupil 7 of the secondary objective 3 by a partially reflecting beam splitter 11 arranged between the relay optics 4 and the secondary objective 3; a transmitted part of the illumination light 10 is collected in a beam dump 12. The secondary objective 3 focuses the illumination light 10 into the intermediate image space 13, in which a phase modulator 14 is arranged. The phase modulator 14 is designed here as a micromirror array 15 and comprises a plurality of micromirrors 16, the positions of which can be adjusted independently of each other in the direction of the optical axis 17. The micromirrors 16 can assume discrete positions, but particularly the micromirrors 16 can be adjusted continuously. Due to the different positions of the micromirrors 16, the illumination light 10 is (phase) delayed in a varying manner over the intermediate image plane 18. In the situation shown, the focused illumination light 10 falls on the central micromirror, which is located exactly in the intermediate image plane 18 of the secondary objective 3, with zero deflection. The illumination light 10 reflected by this micromirror is (re-)collimated by the secondary objective 3 and imaged by the relay optics 4 from the pupil 7 of the secondary objective 3 into the pupil 8 of the microscope objective 2. (Part of the illumination light 10 is reflected by the beam splitter 11 in the direction of the incident light beam 9. This part of the illumination light 10 reduces the light yield of the imaging system 1 but is irrelevant for the further explanation). The microscope objective 2 focuses the illumination light 10 into the sample space 19, wherein the focus 20 of the illumination light 10 is positioned on the optical axis 17 and in the focal plane 21 conjugate to the intermediate image plane 18.

The light yield of the imaging system 1 shown can be improved, for example, by using a polarization beam splitter instead of a partially transparent beam splitter 11 and by arranging a quarter-wave plate between the polarization beam splitter and the pupil 7 of the secondary objective 3, which circularizes the polarization of the incident illumination light 10 and again linearizes the polarization of the illumination light 10 reflected by the micromirror array, wherein the reflected light beam has a polarization orthogonal to the polarization of the incident light beam 9 and is transmitted by the polarization beam splitter.

The imaging system shown in FIG. 1 is also suitable for carrying out an imaging method according to the present disclosure. For this purpose, the sample is illuminated with illumination light 10, wherein the illumination can be carried out using the imaging system 1 shown or an additional (not shown) illumination system. The additional illumination system may have the same structure as the imaging system shown, but it can also implement conventional spot or area illumination of the sample. In the imaging method according to the present disclosure, the beam path shown for the illumination light 10 corresponds to the beam path of the detection light 30, but in the opposite direction of propagation. The detection light 30 originates in the sample and is collected by the microscope objective 2. The detection light emerging from the pupil 8 is imaged by the relay optics 4 into the pupil 7 of the secondary objective 3 and focused by the latter onto the phase modulator 14 in the intermediate image space 13. The light reflected by the micromirrors 16 of the phase modulator 14 is collimated by the secondary objective 3, exits the pupil 7 and is reflected out of the beam path of the imaging system 1 by the beam splitter 11. The decoupled beam can be focused with a lens into an image plane in which a detector, in particular a camera, can be arranged (not shown). In this arrangement, surface elements in the sample conjugated to the micromirrors 16 are imaged into the image plane, wherein the surface elements may have different positions along the optical axis 17 depending on the position of the micromirrors 16.

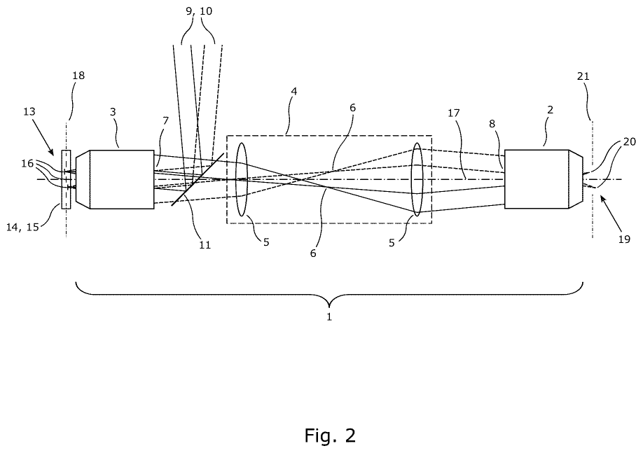

FIG. 2 shows the imaging system 1 already shown in FIG. 1, wherein the light beam 9 of the illumination light 10 is shown at two other angles of incidence. In the first beam path, shown with continuous lines, the light beam 9 enters the pupil 7 of the secondary objective 3 at an angle, so that the illumination light 10 strikes a micromirror 16 above the optical axis 17. This micromirror 16 is slightly displaced relative to the central micromirror and is at a greater distance from the secondary objective 3, as a result of which the optical path length for the illumination light 10 is increased relative to the central micromirror 16, i.e., the illumination light 10 is phase-delayed to a greater extent. The reflected illumination light 10 collected by the secondary objective 3 emerges from the pupil 7 at an angle and slightly convergent. The intermediate focus 6 of the illumination light 10 in the relay optics 4 shifts in the direction of the secondary objective 3 due to this pre-focusing and also enters the pupil 8 of the microscope objective 2 slightly convergent from the relay optics 4. Due to the pre-focusing, the focus 20 of the illumination light 10 in the sample space 19 is not in the focal plane 21, but closer to the microscope objective 2.

In the second beam path, shown with dashed lines, the light beam 9 also enters the pupil 7 of the secondary objective 3 at an angle, but with a reversed inclination compared to the first beam path, so that the illumination light 10 strikes a micromirror 16 below the optical axis 17. This micromirror 16 is also axially displaced relative to the central micromirror, but has a smaller distance to the secondary objective 3, as a result of which the optical path length for the illumination light 10 is reduced relative to the central micromirror 16, i.e., the illumination light 10 is less phase-delayed. The reflected illumination light 10 collected by the secondary objective 3 emerges from the pupil 7 at an angle and slightly divergent. The intermediate focus 6 of the illumination light 10 in the relay optics 4 shifts in the direction of the microscope objective 2 due to this pre-focusing and also enters the pupil 8 of the microscope objective slightly divergently from the relay optics 4, so that the focus 20 of the illumination light 10 in the sample space 19 is not in the focal plane 21, but further away from the microscope objective 2.

The angle of incidence of the light beam 9 can be changed using a beam deflection device (not shown), which is arranged outside the beam path of the imaging system 1 and particularly in a plane conjugate to the pupil 7.

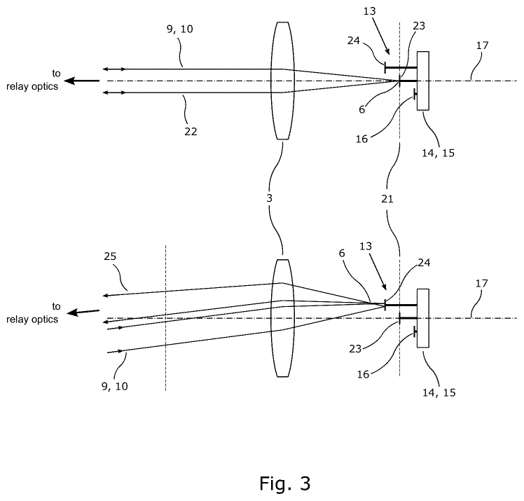

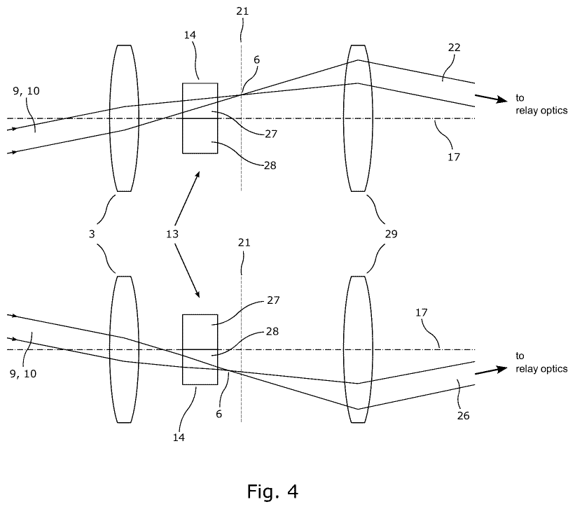

FIG. 3 and FIG. 4 show sections of the imaging system 1 of the light microscope according to the present disclosure, wherein the sections each comprise only the symbolically depicted secondary objective 3, the phase modulator 14 and optionally a further objective 29. The two figures show embodiments in which the phase modulator is designed as a reflective micromirror array 15 (FIG. 3) or as a transmissive phase modulator (FIG. 4) with two different delay elements 27, 28.

In each case, the beam path of the illumination light 9 is shown for two different angles of incidence, as a result of which the focused illumination light falls on different elements of the phase modulator—different micromirrors 16, 23, 14 or different delay elements 27, 28—and is delayed to different degrees.

The upper part of FIG. 3 shows an (illumination) light beam 9 incident from the left along the optical axis 17, which is focused by the secondary objective 3 into the intermediate image space 13 to the intermediate focus 6 in the focal plane 21 of the secondary objective 3, where it is reflected back by the central micromirror 23 of the micromirror array 15. The reflected illumination light 10 is recollimated by the secondary objective 3, and the exciting collimated light beam 22 propagates in the opposite direction to the incident light beam 9 further in the direction of the relay optics (not shown). The lower part of FIG. 3 shows a light beam 9 entering the secondary objective 3 at an angle, which strikes a micromirror 24 located above the optical axis 17, which is displaced in the direction of the secondary objective 3 and is positioned in front of the focal plane 21. The intermediate focus 6 of the illumination light 10 therefore lies behind the micromirror 24 in the beam direction and at a distance from the secondary objective 3 that is less than the distance of the focal plane 21. The reflected illumination light 10 is therefore not recollimated but emerges from the secondary objective 3 as a divergent light beam 25 and propagates to the relay optics (not shown). Due to the beam divergence, the illumination light is focused by the microscope objective located in the further beam path to a greater depth in the sample than the collimated light beam 22 from FIG. 3, upper part.

In the upper part of FIG. 4, a beam of (illumination) light 9 incident obliquely upwards from the left is shown, which is focused into the intermediate image space 13 by the secondary objective 3. The illumination light 10 passes through the delay element 27 of the phase modulator 14, which has a refractive index identical to the surrounding medium of the intermediate image space 13, so that the light beam is focused unrefractedly to the intermediate focus 6 in the focal plane 21 of the secondary objective 3. In the transmission arrangement shown, the focused illumination light 10 is not recollimated by the secondary objective 3, but by a further objective 29, which is particularly identical in construction to the secondary objective 3.

In the lower part of FIG. 4, a light beam 9 incident obliquely downwards into the secondary objective 3 is shown, which is also focused into the intermediate image space 13 by the secondary objective 3. The illumination light 10 passes through the delay element 28 of the phase modulator 14, which has a greater refractive index than the surrounding medium of the intermediate image space 13, so that the light beam is refracted and the intermediate focus 6 is formed in front of the focal plane 21. The illumination light 10 is therefore not recollimated by the objective 29 but emerges from the objective 29 as a convergent light beam 26 and propagates to the relay optics (not shown). Due to the beam convergence, the illumination light is focused to a lesser depth in the sample by the microscope objective located in the further beam path than the collimated light beam 22 from FIG. 4, upper part.

The different phase delay caused by the delay elements 27, 28 can be adjusted as described by different refractive indices of the delay elements 27, 28, but also by different thicknesses of the delay elements 27, 28. It is not absolutely necessary, but a particular embodiment, that the phase delay is adjustable, as is the case, for example, with phase modulators based on liquid crystals.

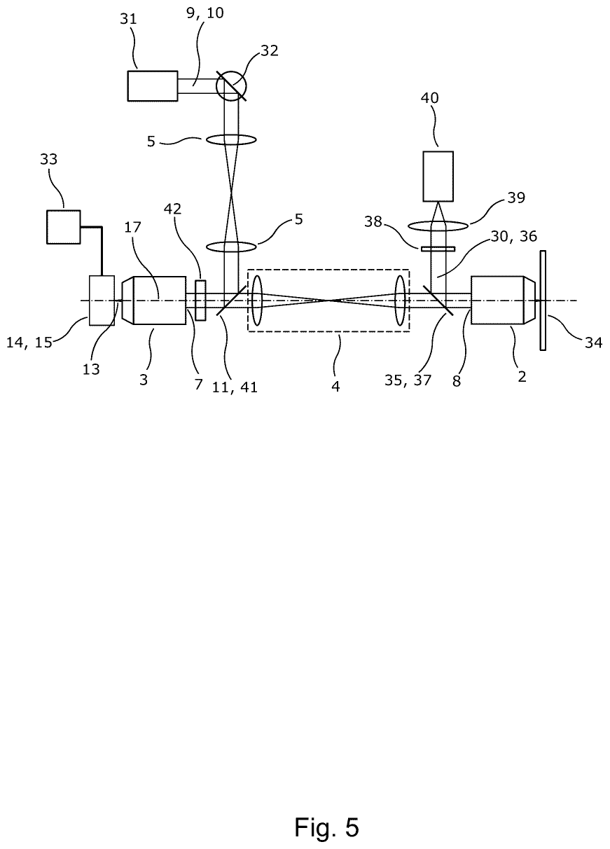

FIG. 5 shows a light microscope according to the present disclosure. A light source 31 emits illumination light 10, which is deflected by a tiltable mirror 32 and directed into the rear pupil 7 of the secondary objective 3 via a beam splitter 11. The tiltable mirror 32, which may in particular be a galvanometer mirror, is imaged into the pupil 7 by the lenses 5, i.e., it is in a plane conjugate to the pupil 7. For the sake of clarity, only one tiltable mirror 32 is shown for the deflection of the illumination light beam 9 in one spatial direction; an extension to a deflection in two spatial directions will be carried out by the skilled person as required. A spatially resolving phase modulator 14, which is designed here as a micromirror array 15, is arranged in the intermediate image space 13. The micromirrors (not shown individually) of the micromirror array 15 can be positioned independently of one another in the axial direction (i.e., in the direction of the optical axis 17), wherein the micromirrors are controlled and positioned via the control device 33.

The illumination light focused by the secondary objective 3 strikes one of the micromirrors, is reflected by it and collected again by the secondary objective 3. Therein, it depends on the deflection of the tiltable mirror 32 at which point in the intermediate image space 13 the illumination light 10 is focused and on which of the micromirrors it falls. The reflected illumination light 10 emerges from the pupil 7 of the secondary objective 3, is imaged by the relay optics 4 into the pupil 8 of the microscope objective 2 and focused by the latter into the sample 34. The axial position of the illumination focus in the sample 34 depends on the axial position of the corresponding micromirror in the intermediate image space and can be changed by an axial displacement of this micromirror. In addition, different micromirrors of the micromirror array 15 may have different axial positions, so that the illumination light 10 is focused to different axial positions in the sample for different deflections of the tiltable mirror 32.

Detection light 30 induced in the sample 34 by illumination with the illumination light 10 is collected by the microscope objective 2 and separated from the incident illumination light 10 at the beam splitter 35. The detection light 30 may in particular be fluorescent light 36, which is red-shifted in its wavelength compared to the illumination light 10 and can be separated from the illumination light 10 with low loss using a color beam splitter 37. The detection light 30 passes through a filter 38, which suppresses interfering scattered light, and is focused onto a detector 40 by a lens 39.

In the embodiment of the light microscope shown, the beam splitter 11 is designed as a polarization beam splitter 41, and a quarter-wave plate 42 is arranged in front of the pupil 7 of the secondary objective 3. Incident, linearly polarized illumination light 10 is circularized as it passes through the quarter-wave plate 42. On the return path, i.e., after reflection by one of the micromirrors of the micromirror array 15, the circularly polarized illumination light 10 is linearized again as it passes through the quarter-wave plate 42, wherein the resulting linear polarization is orthogonal to the linear polarization of the incident illumination light 10 and is transmitted by the polarization beam splitter 41.

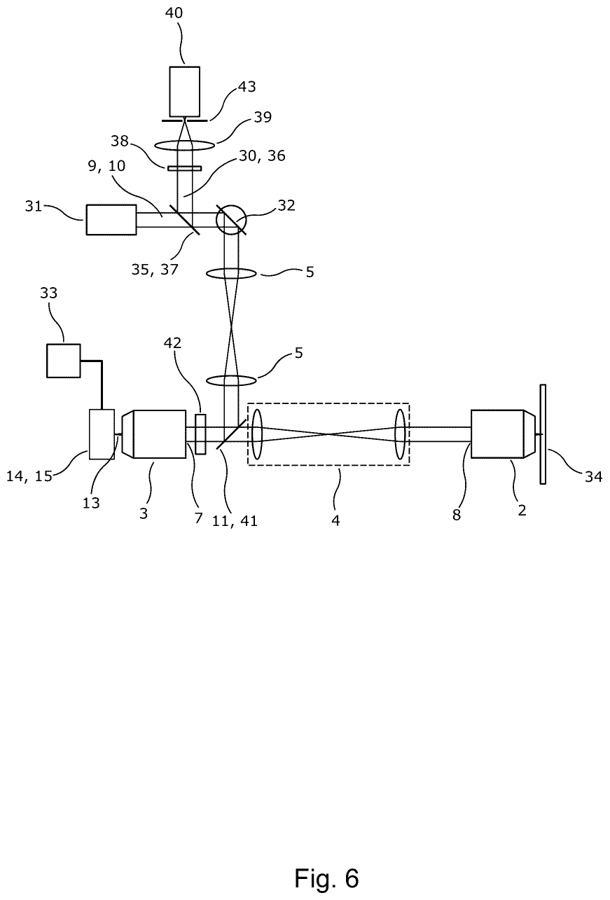

FIG. 6 shows a further light microscope according to the present disclosure. In contrast to the embodiment shown in FIG. 5, here the detection light 30 is not coupled out directly behind the pupil 8 of the microscope objective 2, but the detection light 30 passes through the illumination light path in the opposite direction to the illumination light 10. This means that the detection light 30 is also modulated by the phase modulator 14 and deflected by the tiltable mirror 32 and is thus de-scanned in both the axial and lateral directions. The color beam splitter 37, which separates the detection light 30 from the illumination light 10, is arranged behind the tiltable mirror 32 (viewed in the direction of propagation of the detection light 30). The reflected detection light 30 is focused onto the detector 40 by the lens 39. Since the detection light 30 is de-scanned here, unlike in FIG. 5, a (confocal) pinhole 43 can be arranged in front of the detector 40 to suppress out-of-focus components of the detection light 30.

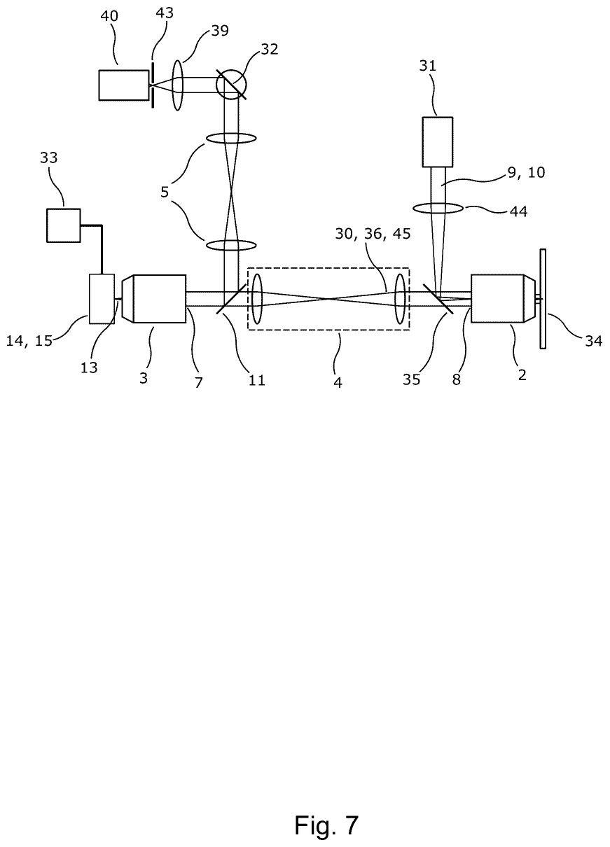

FIG. 7 shows a light microscope according to the present disclosure in which only the detection light 30, but not the illumination light 10, is phase-modulated in the intermediate image area 13. In this embodiment, the illumination light 10 provided by the light source 31 is coupled into the pupil 8 of the microscope objective 2 by the beam splitter 35, wherein the illumination light 10 is focused into the pupil 8 by the lens 44. This illumination configuration is therefore a wide-field illumination in which the sample 34 is not illuminated in a point-like manner, but over an extended area simultaneously with the illumination light 10. Detection light 30 emitted by objects in the sample 34 as a result of the illumination with the illumination light 10 (for example fluorescent light 36 or scattered light 45) is separated from the illumination light 10 at the beam splitter 35 and imaged by the relay optics into the pupil 7 of the secondary objective 3. (Part of the detection light 30 is reflected out of the beam path by the beam splitter 11, which reduces the detection efficiency but is irrelevant for the basic operation of the light microscope). The detection light 30 is focused into the intermediate image space 13, where it is phase-delayed by the phase modulator 14 in a spatially varying fashion. Via the imaging system formed by the lenses 5, the detection light 30 reflected by the phase modulator 14 and collected by the secondary objective 3 is imaged onto the tiltable mirror 23 and further directed by it onto the detector 40, where it is focused by the lens 39 through the pinhole 43 arranged in front of the detector.

In this arrangement, depending on the position of the tiltable mirror 32 and the spatial distribution of the phase delay, only the point in the sample conjugate to the pinhole 43 is detected via the phase modulator 14. By adjusting the tiltable mirror 32 and/or the phase modulator 14, different locations in the sample can thus be addressed in succession without these locations having to be arranged in a single imaging plane, or a (non-planar) contour of an object in the sample can be scanned.

This embodiment is also particularly suitable for the implementation of a sample stabilization system in which the detection is directed successively to different reference markers located at different locations in the sample in order to repeatedly determine the locations of the reference markers.

### LIST OF REFERENCE SIGNS

1 Imaging system
2 Microscope objective
3 Secondary objective
4 Relay optics
5 Lens
6 Intermediate focus
7 Pupil
8 Pupil
9 Light beam
10 Illumination light
11 Beam splitter
12 Beam dump
13 Intermediate image space
14 Phase modulator
15 Micro mirror array
16 Micro mirror
17 Optical axis
18 Intermediate image plane
19 Sample space
20 Focus
21 Focal plane
22 Light beam (collimated)
23 Micro mirror
24 Micro mirror
25 Light beam (divergent)
26 Light beam (convergent)
27 Delay element
28 Delay element
29 Objective
30 Detection light
31 Light source
32 Tiltable mirror
33 Control device
34 Sample
35 Beam splitter
36 Fluorescent light
37 Color beam splitter
38 Filter
39 Lens
40 Detector
41 Polarization beam splitter
42 Quarter-wave plate
43 Pinhole
44 Lens
45 Scattered light

1. A method for illuminating a sample in a light microscope, wherein the sample is illuminated through a microscope objective at a plurality of illumination positions with focused illumination light, wherein the illumination light is phase-delayed in a varying manner over an intermediate image plane in an intermediate image space of an illumination beam path.

2. The method according to claim 1, wherein the phase delay is adjusted with a deformable mirror, a segmented mirror or a micromirror array with an adjustable shift per micromirror.

3. The method according to claim 1, wherein the intermediate image space is imaged into the sample with an optical system comprising the microscope objective, a secondary objective and relay optics, wherein the intermediate image space comprises a focal plane of the secondary objective.

4. The method according to claim 1, wherein a spatial distribution of the phase delay over the intermediate image plane is set such that the illumination positions are arranged on a curved contour of an object in the sample.

5. The method according to claim 1, wherein a spatial distribution of the phase delay over the intermediate image plane is set such that the illumination positions are directed to different objects in the sample having different axial positions.

6. The method according to claim 1, wherein an emitter in the sample is localized, wherein for each illumination position a quantity of light of an emission light emitted by the emitter in the sample is detected and a position of the emitter in the sample is determined from the quantities of light detected for the illumination positions.

7. The method according to claim 6, wherein the focus of the illumination light in the sample comprises a local intensity minimum surrounded by intensity increase regions in at least one spatial direction.

8. The method according to claim 6, wherein the illumination light excites the emitter to emit the emission light or modulates the emission of the emission light.

9. The method according to claim 6, wherein the position determination of the emitter comprises an axial coordinate of the emitter.

10. The method according to claim 6, wherein the illumination positions comprise at least two groups with at least two illumination positions each or at least one group with at least three illumination positions, wherein the illumination positions within a group comprise the same axial coordinates.

11. The method according to claim 6, wherein the positions of a first and a second emitter in the sample are determined quasi-simultaneously by illuminating the sample in turns at illumination positions assigned to the first emitter and illumination positions assigned to the second emitter, wherein the emission light detected at each illumination position is assigned to the respective emitter.

12. The method according to claim 11, wherein the positions of the first and second emitters differ from one another in their axial coordinates.

13. A method for imaging a sample into an image plane of a light microscope, wherein detection light originating from the sample is phase-delayed in a varying manner over an intermediate image plane in an intermediate image space of the light microscope.

14. The method according to claim 13, wherein a spatial distribution of the phase delay over the intermediate image plane is set such that a curved contour of an object in the sample is imaged into the image plane.

15. The method according to claim 13, wherein the sample is illuminated through a microscope objective at a plurality of illumination positions with focused illumination light, wherein the illumination light is phase-delayed in a varying manner over an intermediate image plane in the intermediate image space.

16. The method according to claim 13, wherein the phase delay in the intermediate image space is adjusted with a deformable mirror, a segmented mirror or a micromirror array with adjustable shift per micromirror.

17. A light microscope comprising an optical imaging system, wherein the optical imaging system comprises
a microscope objective configured to be directed at a sample,
a secondary objective directed into an intermediate image space of the light microscope and
a relay optics which is configured to image pupils of the microscope objective and the secondary objective into one another,
wherein the light microscope further comprises a spatial phase modulator comprising a control device for setting a phase delay profile, wherein the spatial phase modulator is arranged in the intermediate image space of the light microscope and is configured to variably delay illumination light from a light source and/or detection light from the sample over an intermediate image plane.

18. The light microscope according to claim 17, wherein the spatial phase modulator is configured as a deformable or segmented mirror or as a micromirror array with an adjustable shift per micromirror.

19. The light microscope according to claim 17, wherein the light microscope comprises a light source for illumination light, a beam deflection unit arranged in a beam path of the illumination light, and a focusing system configured to focus the illumination light into the intermediate image space.

20. The light microscope according to claim 17, wherein the light microscope comprises optical elements for imaging the intermediate image space into a detection plane and a detector arranged in the detection plane.
